(19) United States
(12) Patent Application Publication
(10) Pub. No.: US 2007/0116268 A1
(43) Pub. Date: May 24, 2007

(54) METHOD OF DELIVERING CONTENT DATA AND COMMUNICATION TERMINAL FOR USE THEREIN

(75) Inventors: Akihiro Kasahara, Sanbu-gun (JP); Akira Miura, Sagamihara-shi (JP); Hiroshi Suu, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/559,657

(22) Filed: Nov. 14, 2006

(30) Foreign Application Priority Data
Nov. 22, 2005 (JP) 2005-337063

(51) Int. Cl. H04L 9/28

(52) U.S. Cl. 380/28

(57) ABSTRACT

A method of delivering content data is provided that makes content data able to be reproduced at a user terminal by delivering content key data necessary to decrypt the content data. Specifically, portable storage media storing in advance the content data encrypted with the content key data is connected to the user terminal having a unique terminal ID. User key data that is provided with a predetermined expiration date and is necessary to encrypt the content key data is transmitted from a server to the user terminal. The user key data is stored in an internal memory in the user terminal in such a way that the user key data is unable to be read out of the internal memory. The content key data necessary to decrypt the content data stored in the portable storage media is encrypted with the user key data, and the encrypted content key data is stored in the user terminal or the portable storage media.

### CROSS REFERENCE TO RELATED APPLICATIONS

This application is based on and claims the benefit of priority from prior Japanese Patent Application No. 2005-337063, filed on Nov. 22, 2005, the entire contents of which are incorporated herein by reference.

### BACKGROUND OF THE INVENTION

1. Field of the Invention

The present invention relates to a method of delivering content data and a handheld terminal for use therein.

2. Description of the Related Art

With the recent development of the information society, a content delivery system has become commonly used that delivers from a server to a user terminal via the Internet or the like electronic content data such as an electronic book, a newspaper, music, and a moving picture and the like and makes the content data available to the user (see, for example, JP-A 10-149619 (KOKAI)). Before being delivered, the content data is usually encrypted with a content key data or the like, and the content key data in turn is encrypted with, for example, a user key data specific to a user terminal and is transmitted, in order to prevent the content from being used illegally. Such a content delivery system is used in equipment such as a handheld device or a personal computer that may access the server via a network, and is also used in reproduction equipment that may copy the data acquired by the above equipment.

The server delivers the content data to the user terminal most commonly in the “buy” format in which the user buys the content data. The “buy” format, however, tends to keep a high content-delivery fee because of the difficulty of the copyright management or the like.

A “subscribe” (also is referred to as “subscription”) format is also known in which the content data is provided with an expiration date, and the content data is available within the period but is unavailable after the expiration date has elapsed. The subscribe format may deliver the content data less expensively than the content data buy format because of the content data being limited within the expiration date.

The subscribe format may be achieved, theoretically, by a “streaming” delivery in which the content data is reproduced while being downloaded, or by a download delivery by downloading the key-encrypted content data. The former has a problem, however, that it may be achieved with a handheld terminal but often with an insufficient bandwidth, thus giving stress to the user and a higher communication fee. The latter does not have a significant problem even with an insufficient bandwidth, but it presents a difficult management of the expiration date, and particularly, because some of the handheld terminals may not provide accurate time information, it is difficult to deliver the content data with the copyright protection collectively secured.

### SUMMARY OF THE INVENTION

According to an aspect of the present invention, there is provided a method of delivering content data that makes content data able to be reproduced at a user terminal by delivering content key data necessary to decrypt the content data, comprising: connecting portable storage media storing in advance the content data encrypted with the content key data to the user terminal having a unique terminal ID; transmitting from a server via a first network to the user terminal user key data that is provided with a predetermined expiration date and is necessary to encrypt the content key data, and storing the user key data in an internal memory of the user terminal in such a way that the user key data is unable to be read out of the internal memory, the internal memory being under control of application software stored in the user terminal; and encrypting the content key data necessary to decrypt the content data stored in the portable storage media with the user key data, and storing the encrypted content key data in the user terminal or the portable storage media.

According to another aspect of the present invention, there is provided a communication terminal that is adapted to be able to connect to portable recording media storing content data encrypted with content key data and is adapted to be able to connect to a server that delivers a user key data that is provided with an expiration date and is necessary to encrypt at least the content key data, comprising: an internal memory storing various data; and application software that is stored in the internal memory and performs a communication control to receive at least the user key data from the server via a first network, wherein the application software has functions of storing the user key data in the internal memory in such a way that the user key data is unable to be read out of the internal memory, and receiving, at a predetermined timing, authentication from the server and update of the expiration date.

### BRIEF DESCRIPTION OF THE DRAWINGS

FIG. 1 is a schematic diagram of the entire configuration of a content data delivery system of a first embodiment of the present invention;

FIG. 2 is a block diagram of the specific configuration of the handheld terminal 30 shown in FIG. 1;

FIG. 3 is a flowchart of the procedure of the reproduction of the content data in the handheld terminal 30 in the content data delivery system of the first embodiment;

FIG. 4 is a flowchart of another example of the procedure of the reproduction of the content data in the handheld terminal 30 in the content data delivery system of the first embodiment;

FIG. 5 is a flowchart of the detailed procedure of determining the validity of the member registration at step S2 in FIG. 3 or step S22 in FIG. 4;

FIG. 6 is a schematic diagram of the entire configuration of the content data delivery system of a second embodiment of the present invention;

FIG. 7 is a flowchart of the procedure of the reproduction of the content data in the handheld terminal 30 in the content data delivery system of the second embodiment;

FIG. 8 is a flowchart of another example of the procedure of the reproduction of the content data in the handheld terminal 30 in the content data delivery system of the second embodiment;

FIG. 9 is a schematic diagram of the entire configuration of the content data delivery system of a third embodiment of the present invention;

FIG. 10 is a flowchart of the procedure of the reproduction of the content data in the handheld terminal 30 in the content data delivery system of the third embodiment;

FIG. 11 is a flowchart of another example of the procedure of the reproduction of the content data in the handheld terminal 30 in the content data delivery system of the third embodiment;

FIG. 12 is a schematic diagram of the entire configuration of the content data delivery system of a fourth embodiment of the present invention;

FIG. 13 is an example of various key data owned by the user in the fourth embodiment;

FIG. 14 illustrates the procedure of buying the content data in the fourth embodiment;

FIG. 15 illustrates the procedure of buying the content data in the fourth embodiment;

FIG. 16 illustrates the procedure of buying the content data in the fourth embodiment;

FIG. 17 illustrates the procedure of buying the content data in the fourth embodiment;

FIG. 18 is an example of a cipher algorithm in the system of the fourth embodiment;

FIG. 19 is a modified example of an embodiment of the present invention; and

FIG. 20 is a modified example of an embodiment of the present invention.

### DETAILED DESCRIPTION OF THE EMBODIMENTS

Preferred embodiments of the present invention will be described in more detail with reference to the accompanying drawings.

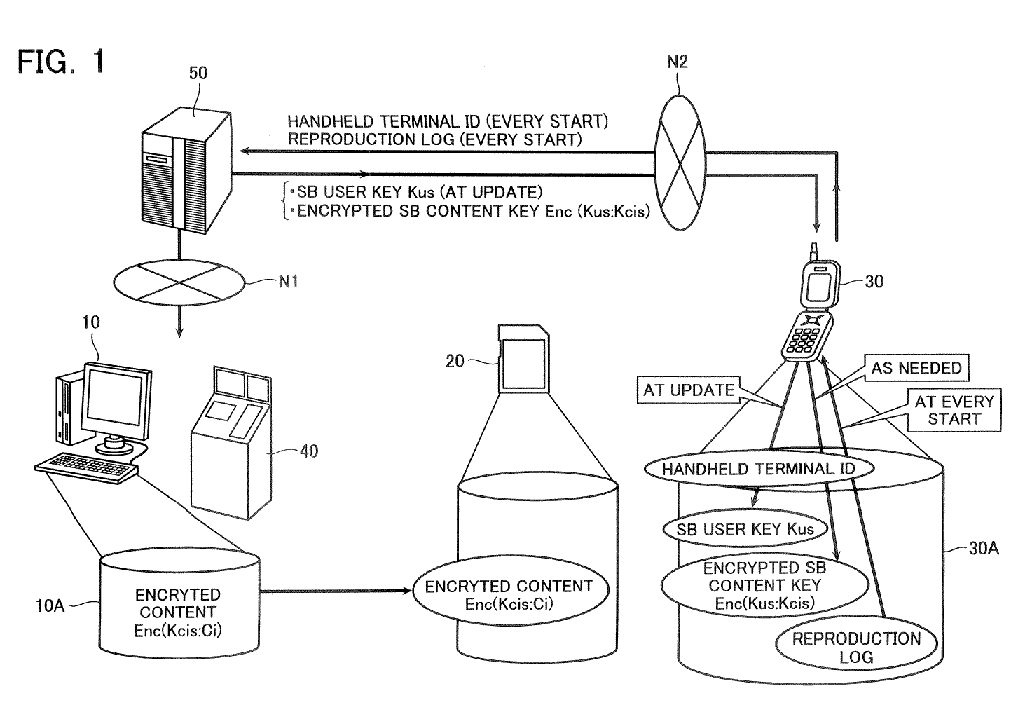

(First Embodiment) FIG. 1 is a schematic diagram of the entire configuration of a content data delivery system of a first embodiment of the present invention. In this system, a user may have a personal computer (PC) 10, a SD memory card (SD card) 20, and a handheld terminal 30 (user terminal) or the like. A content provider or the like may have a server 50, which provides, via the Internet N1 or a handheld terminal packet network N2, the content data and various key data for encrypting the content data or the like. In this system, the server 50 basically does not distribute the content data in a sale (buy) format, but uses a subscribe format in which a predetermined expiration date is set during which the content data may be viewed and/or heard. Note that although FIG. 1 illustrates the server 50 as a single one, a plurality of servers classified into different functions may be coupled to each other.

The PC 10 is a communication terminal that may perform broadband communication via the Internet N1. The handheld terminal 30 is a communication terminal that may only perform narrow band communication via the handheld terminal packet network N2. In this environment, the user connects the SD card 20 to the PC 10 to access the server 50, and downloads from a content-data download site provided by the server 50 content data Ci encrypted with a subscribe content key data Kcis (the subscribe content key data is hereinafter referred to as SB content key data, and the encrypted content data Ci is hereinafter described as Enc (Kcis:Ci), note that the subscript s denotes the subscribe format), and writes the data in a hard disk drive 10A or the like, and then transfers and writes the data in a user area of the SD card 20. The content provider or a company under contract with the content provider or the like may place at stores, such as a convenience store, a store terminal 40 that is also connected via the Internet or a leased (dedicated) line to the server, thereby allowing the user to download the encrypted content data Enc (Kcis:Ci) in the same procedure as described above. At this point, the user does not have the content key data Kcis, so the user cannot reproduction the content data Ci.

A user who wishes to reproduce the content data Ci connects the SD card 20 with the encrypted content data Enc (Kcis:Ci) written therein to a not-shown SD card slot of the handheld terminal 30. The user then starts application software (hereinafter referred to simply as “application”), which is used for viewing and/or hearing content data stored in the handheld terminal 30. Then the user accesses via the handheld terminal packet network N2 the server 50.

Each handheld terminal 30 is allocated a different unique handheld terminal ID. The user uses the handheld terminal ID and other identification data to make a member contract with the content provider managing the server 50 on the subscribe format delivery service of the content data. The member contract may be newly made and updated via the handheld terminal packet network N2.

The handheld terminal 30 includes an internal memory 30A to store the handheld terminal ID or the like. The internal memory 30A stores a subscribe user key data (hereinafter referred to as SB user key data) Kus, which is received from the server 50 by the operation of the above application, and subscribe content key data Enc (Kus:Kcis) encrypted with the subscribe user key data Kus. The SB user key data Kus is provided with an expiration date, and it is updated every time the expiration date expires or the user requests the update.

The internal memory 30A also stores reproduction log information that lists the decrypted and reproduced content data Ci. The reproduction log information is updated every time the application reproduces the content data, and is transmitted to the server 50 every time the application is started.

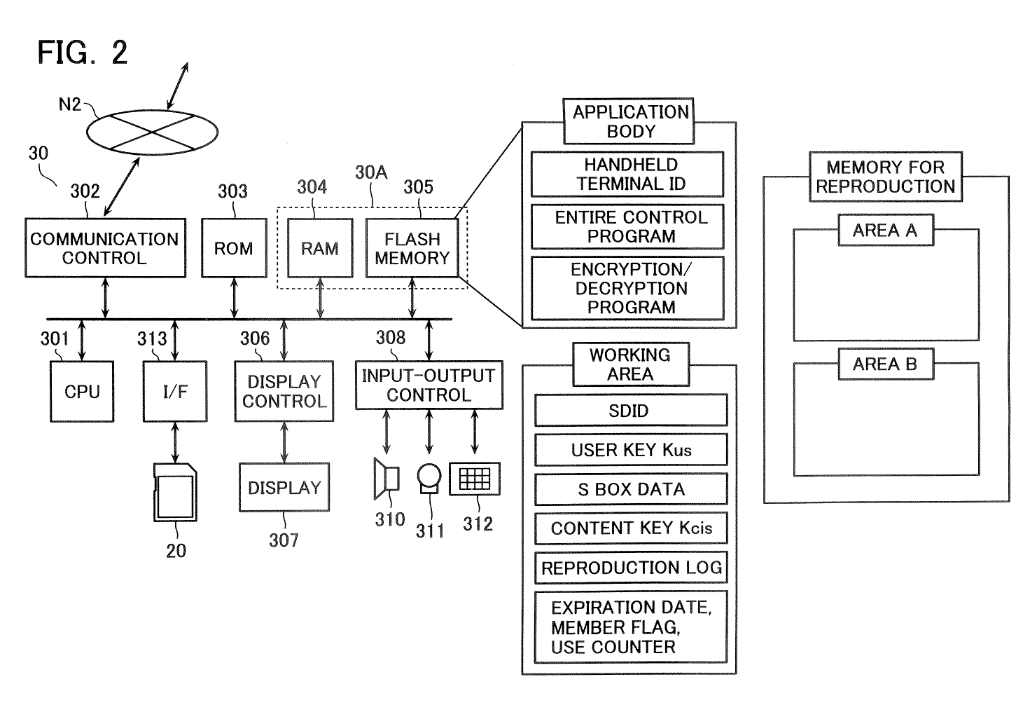

(Configuration of Handheld terminal 30) The specific configuration of the handheld terminal 30 is described below with reference to the block diagram in FIG. 2. The handheld terminal 30 includes a CPU 301, a communication control portion 302, a ROM 303, a RAM 304 and a flash memory 305, a display control portion 306, a display 307, an input-output control portion 308, a speaker 310, a microphone 311, a keyboard 312, and an SD card interface 313 or the like. These components are the same as those in the conventional handheld terminal, so their detailed description is omitted here. The RAM 304 and flash memory 305 are included in the internal memory 30A. The flash memory 305 may only be included in the internal memory 30A. The application described above and other data to be stored are stored in the flash memory 305 in a non-volatile manner. Data to be temporarily stored for the reproduction of the content data is stored in the RAM 304.

The internal memory 30A may be divided into three areas: an application-body storage area for storing the application body in a non-volatile manner, a working area, and a memory area for reproduction. The application-body storage area stores the application described above. The application may be broadly classified into two programs: an entire control program for the entire control including the upload/download of the various data and the reproduction of the content data or the like, and the encryption/decryption program for the encryption/decryption of the data.

The working area stores a media identifier SDID of the SD card 20, the user key data Kus, S-box data, the encrypted content key data Enc (Kus:Kcis), the reproduction log, and illegal-use prevention data (expiration date, member flag, use counter) and the like. Among the data in the working area, certain data, particularly the user key data Kus is stored, by the entire control program of the application, in the protection area set in the working area to prevent the use key data from being read out of the handheld terminal 30.

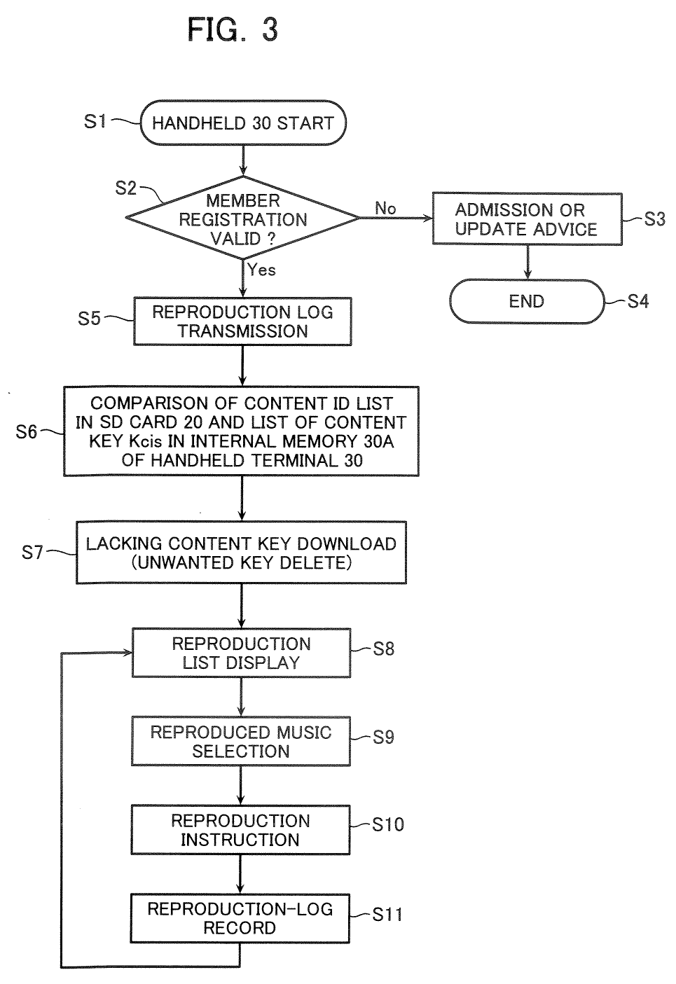

(Content Data Reproduction Procedure 1) The procedure of the reproduction of the content data by the handheld terminal 30 in this system is described with reference to the flowchart in FIG. 3.

First, the handheld terminal 30 having connected thereto the SD card 20 that stores the encrypted content data Enc (Kcis:Ci) as described above is started (S1), and the application accesses the server 50 to transmit the handheld terminal ID or the like to the server 50, and then the server 50 determines, according to the expiration date data or the like of the user key data Kus specified from the handheld terminal ID or the like, whether the user's member registration is valid (S2). The determination may not be performed by the server 50, but by the handheld terminal 30 itself. The procedure will be described in more detail below. If it is determined that the member registration is invalid, then admission to the content delivery service or the membership update is advised, and the application is ended (S3, S4).

If the member registration is valid, then the server 50 requests the handheld terminal 30 to transmit the reproduction log information to the server 50 and the handheld terminal 30 transmits the reproduction log information (S5). The server 50 distributes, according to the reproduction log information, the copyright royalty to the songwriter, composer, artist, and a provider company and the like of the content data viewed and/or heard.

The handheld terminal 30 then compares, according to the operation of the application, the content ID list of the content data Ci in the SD card 20 and the list of the content key data Kcis stored in the internal memory 30A in the handheld terminal 30 (S6). If the comparison shows that, for example, the user newly downloads the content data from the PC 10 and stores it in the SD card 20 but the corresponding content key data Kcis is not yet stored in the internal memory 30A, then the content key data Kcis is downloaded as the lacking content key data from the server 50 (S7). Conversely, the content key data Kcis without the corresponding content data Ci stored in the SD card 20 is deleted as unwanted content key data from the internal memory 30A.

After all of the lacking content key data is thus downloaded, the handheld terminal 30 displays on its display 307 a reproduction list that lists the content data that may be reproduced (S8). From the reproduction list, the music (i.e., the content data) to be reproduced is selected (S9), and the reproduction is instructed (S10), and then the content data starts to be reproduced. After the reproduction is complete, the application updates the reproduction log (S11) and returns to step S8 where the reproduction list is displayed.

As described above, according to the present embodiment, the encrypted content data Enc (Kcis:Ci) is downloaded in advance via the wide-bandwidth Internet N1, not via the handheld terminal packet network N2, from the server 50 to the PC 10 or the like, thus allowing the handheld terminal 30 to download only the content key data and user key data of about 56 bit, for example, thereby preventing the user from feeling stress for the long download time or the like and providing the less communication fee. The user key data provided with the expiration date is securely stored by the application in the handheld terminal 30 in the handheld terminal 30 in such a way that the user key data may not be read out of the handheld terminal 30, thereby suppressing the illegal use of the copyright.

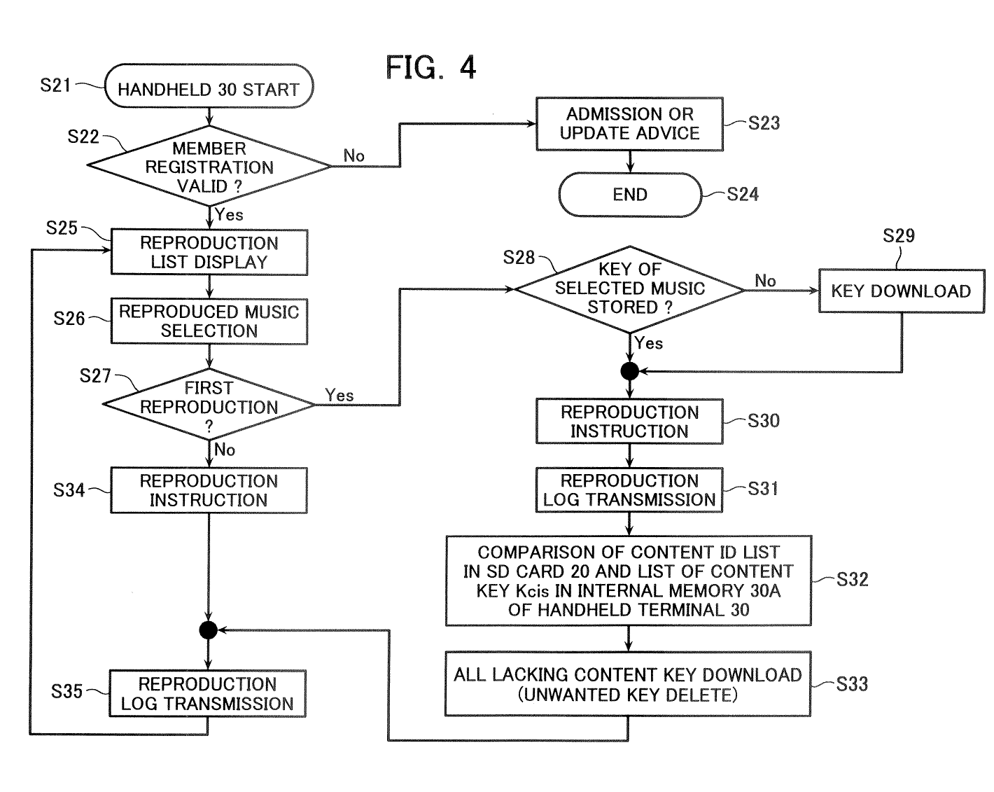

(Content Data Reproduction Procedure 2) Another procedure of the reproduction of the content data by the handheld terminal 30 in this system is described with reference to the flowchart in FIG. 4. The steps from S21 to S24 are the same as the steps from S1 to S4 in FIG. 3. The procedure in FIG. 4 differs from that in FIG. 3 in that after the member registration is determined to be valid (YES at S22) and the reproduction list is displayed (S25) and the music to be reproduced is selected (S26), it is determined, according to the reproduction log information, whether the selected music (i.e., the content data) is on the first (initial) reproduction (S27). If it is on the first reproduction (YES), then it is determined whether the content key data corresponding to the selected music (i.e., the content data) is stored in the internal memory 30A in the handheld terminal 30 (S28). If the corresponding content key data is not stored in the internal memory 30A, then that content key data is downloaded from the server 50 to the handheld terminal 30 (S29), and the content key data is used to instruct the reproduction of the selected content data (S30). If the corresponding content key data is stored in the internal memory 30A, then control passes, not via S29, to S30.

After the reproduction is instructed (S30) and the reproduction log information is transmitted (S31), the content ID list of the content data Ci in the SD card 20 is compared with the list of the content key data Kcis stored in the internal memory 30A in the handheld terminal 30 (S32). If the comparison shows that, for example, the content key data Kcis corresponding to the content data in the SD card 20 is not yet stored in the internal memory 30A, then the content key data Kcis is downloaded as the lacking content key data from the server 50, while the unwanted content key data is deleted from the internal memory 30A (S33). After the reproduction of the content data is thus complete, the reproduced data is recorded as the reproduction-log record to update the reproduction log information (S35).

If the selected music is not on the first reproduction (NO at S27), meaning that the corresponding content key data is already stored in the internal memory 30A, then the reproduction using that content key data is instructed (S34), and subsequently the reproduced data is recorded as the reproduction-log record to update the reproduction log information (S35).

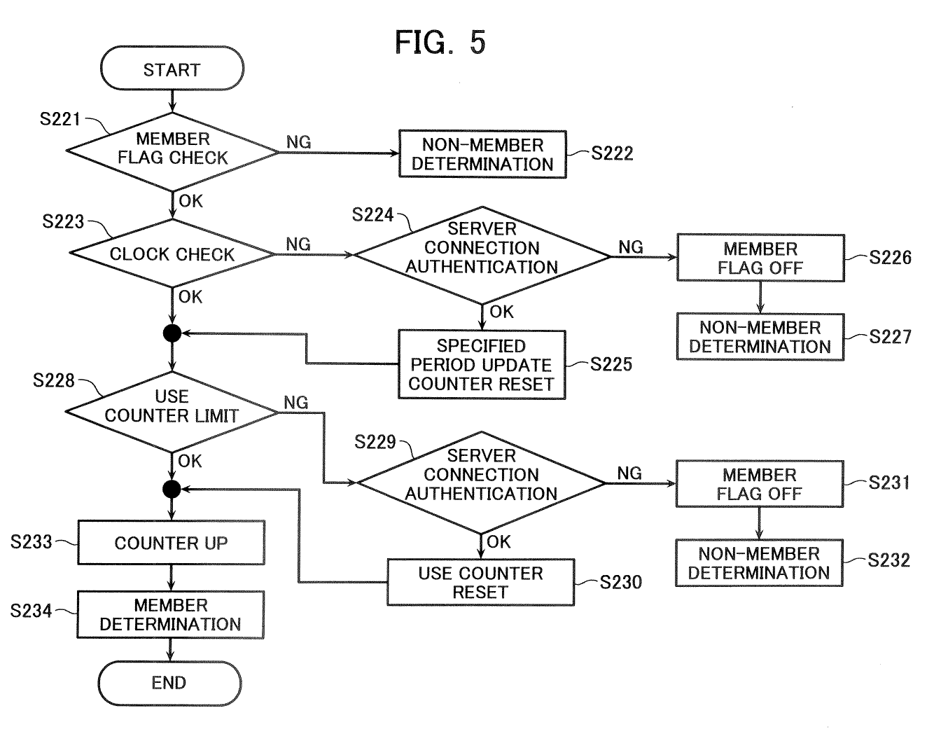

(Member Registration Validity Determination) The procedure of step S2 in FIG. 3 or step S22 in FIG. 4 of determining whether the member registration is valid is described in more detail with reference to the flowchart in FIG. 5. The working area in the internal memory 30A stores, as the data for the validity determination, the expiration date data, member flag, and use counter. The expiration date data is adapted to be set or updated after the member pays the membership fee or the like, and is compared, as described below, with the clock data of the handheld terminal 30. The member flag is set to “1” when the expiration date data or the like recognizes the member registration as valid, and is set to “0” when the member registration is recognized as invalid. The use counter is counted up every time the handheld terminal 30 is started, and is reset to “0” every time the server 50 performs the authentication.

FIG. 5 shows a procedure of determining whether the member registration is valid, in which the member flag is first checked (S221), and if the member flag is “0”, then the user is determined to be a non-member, and control passes to the step where admission to the content delivery service or the membership update is advised (S3 in FIG. 3). If the member flag is “1”, then control passes to S223, where the clock of the handheld terminal 30 is checked and compared with the expiration date data. If the clock data shows that the expiration date has expired, then control passes to S224, where the server 50 performs the authentication. If the authentication is successfully performed using the handheld terminal ID or the like, the expiration date data in the internal memory 30A is updated to the new period data according to the authentication, and the use counter is reset to “0” (S225). If the authentication is denied for a predetermined reason, then the member flag is set to “0”, i.e., OFF (S226), and the user is determined to be a non-member (S227).

After the expiration date check is thus cleared, it is checked whether the use counter exceeds the set limit. If the use counter exceeds the set limit, then the server 50 performs the authentication (S229) as in S224. If the authentication is successfully performed, then the use counter is reset to “0” (S230), and if the authentication is denied, then the member flag is set to OFF and the user is determined to be a non-member (S231, S232). If the use counter does not exceed the set limit, then the use counter is counted up by one point (S233), the user is determined to be a member, and the application is ended (S234). As described above, the procedure in FIG. 5 performs a double check by checking the expiration date using the clock and by checking using the use counter to determine the member registration validity. If the handheld terminal 30 has a correct clock, the user is determined to be a non-member after the expiration date expires. A member who wishes to continue to use the content data needs to update the contract and pay the membership fee or the like and continues to view and/or hear in the subscribe format, thereby preventing the illegal use of the copyright. It may be assumed, however, that a malicious user intentionally operates the clock of the handheld terminal 30 to illegally use the content data after the expiration date expires. To prevent such illegal activities, the use counter may effectively check them as described above. Specifically, every time the clock is illegally operated, the use counter is counted up, and at the set limit, the content data may not be used any more. The counter reset to “0” needs to be done by being connected to and being authenticated by the server 50, so the maximum illegal use may be the set limit of the use counter, thus suppressing the illegal use.

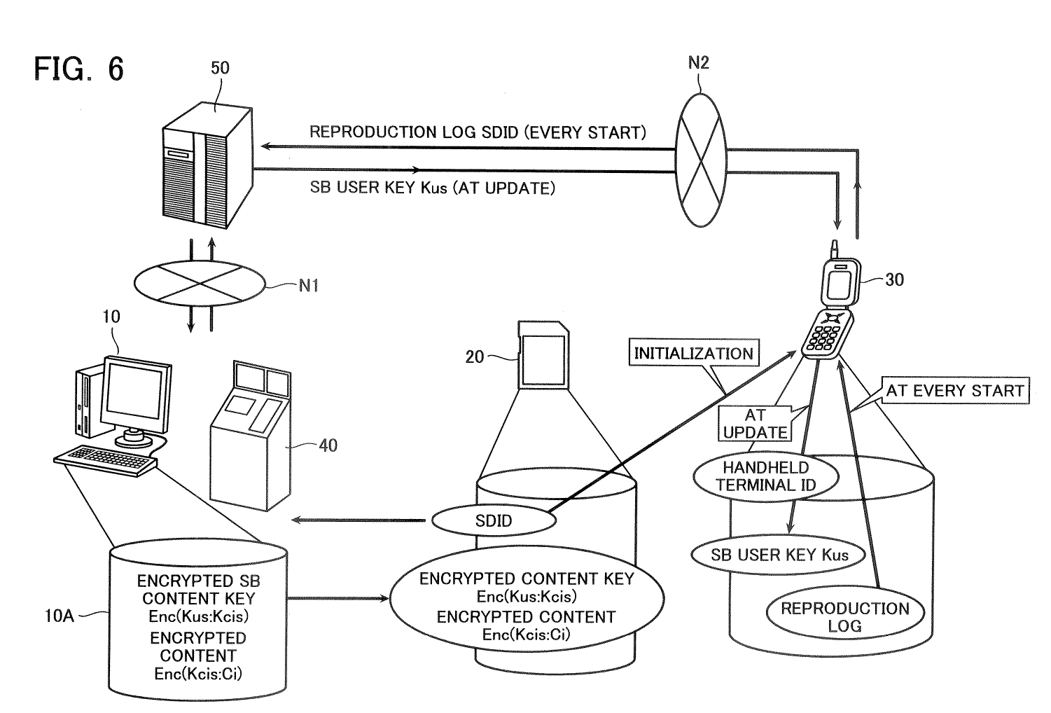

(Second Embodiment) A content data delivery system of a second embodiment of the present invention is described below with reference to FIG. 6. In this embodiment, the encrypted content data Enc (Kcis:Ci) as well as the SB content key data Enc (Kus:Kcis) encrypted with the user key data Kus are written via the Internet N1 from the PC 10 or the like to the SD card 20. The handheld terminal 30 downloads via the handheld terminal packet network N2 only the SB user key Kus from the server. In this embodiment, the SD card 20 and the handheld terminal 30 are associated by the server 50, so the media identifier SDID of the SD card 20 and the handheld terminal ID of the handheld terminal 30 are together transmitted to the server 50 as described below. The server 50 associates the transmitted media identifier SDID and handheld terminal ID and saves them in the database so that the same user key Kus is subsequently transmitted to them.

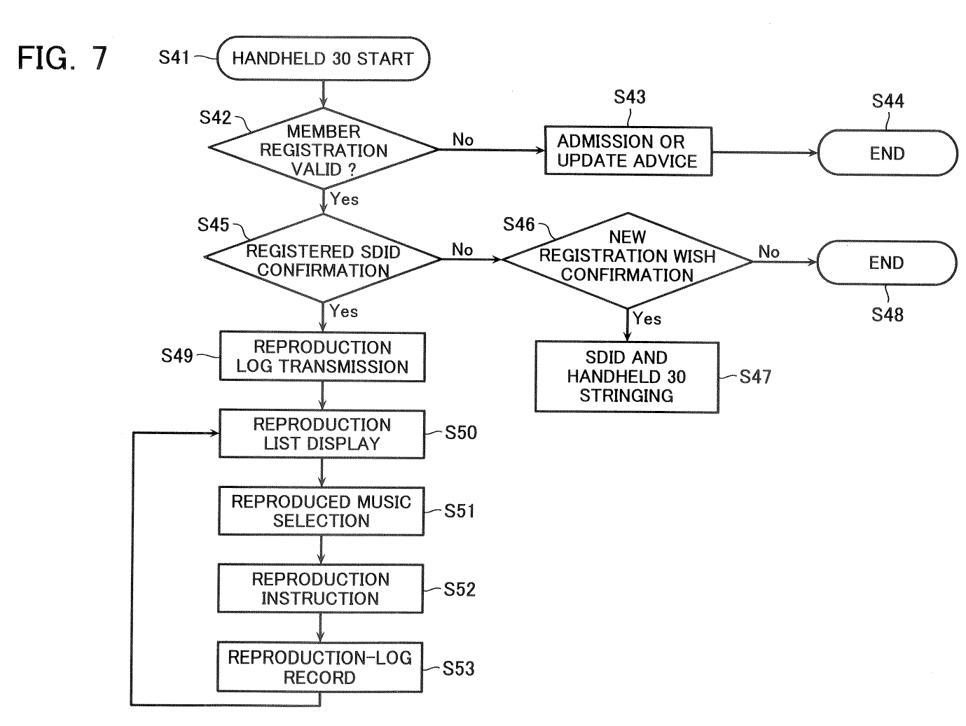

(Content Data Reproduction Procedure 1) FIG. 7 is a flowchart of the procedure of the reproduction of the content data in the handheld terminal 30 in the content data delivery system of the second embodiment. The steps from S41 to S44 are the same as the steps from S1 to S4 in FIG. 3. At the next step S45, by referring to the handheld terminal ID of the handheld terminal 30, it is confirmed whether the media identifier SDID of the connected SD card 20 is already registered (or associated). If the registration is not complete, then it is asked by the server 50a whether the user wishes to newly register the SD card 20 (S46), and if it is inputted that the new registration is wished, then the media identifier SDID and the handheld terminal ID of the handheld terminal 30 are associated (stringed)(S47), and the associated SD card 20 is subsequently available. If it is inputted in the handheld terminal 30 that the new registration is not wished, then the procedure is ended (S48). If, at step 45, the media identifier SDID is already registered (YES), the reproduction log information is transmitted to the server 50 (S49), and then the procedure from S50 to S53 the same as the steps from S8 to S11 in FIG. 3 is performed to reproduce the content data.

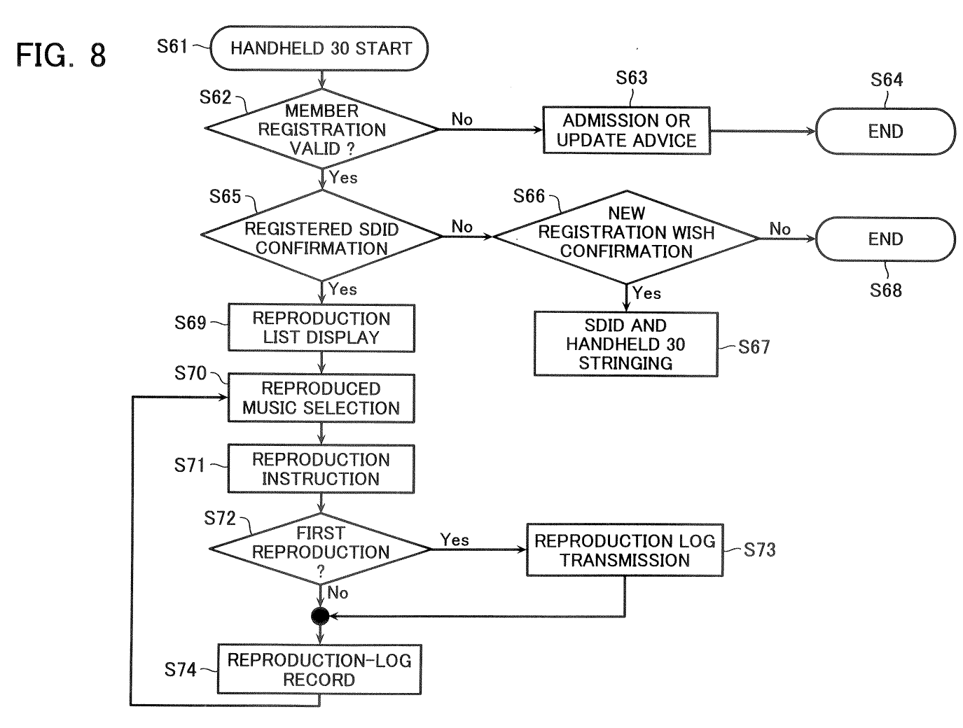

(Content Data Reproduction Procedure 2) FIG. 8 is a flowchart of another example of the procedure of the reproduction of the content data in the handheld terminal 30 in the content data delivery system of the second embodiment. The steps from S61 to S68 are the same as the steps from S41 to S48 in FIG. 7. The steps from S69 to S71 and S74 are the same as the steps S50 to S53 in FIG. 7. The procedure in FIG. 8 differs from that in FIG. 7, however, in that after step S71, at step S72, it is determined whether the selected music (content data) is on the first (initial) reproduction, and if so, then the reproduction log information is transmitted to the 50.

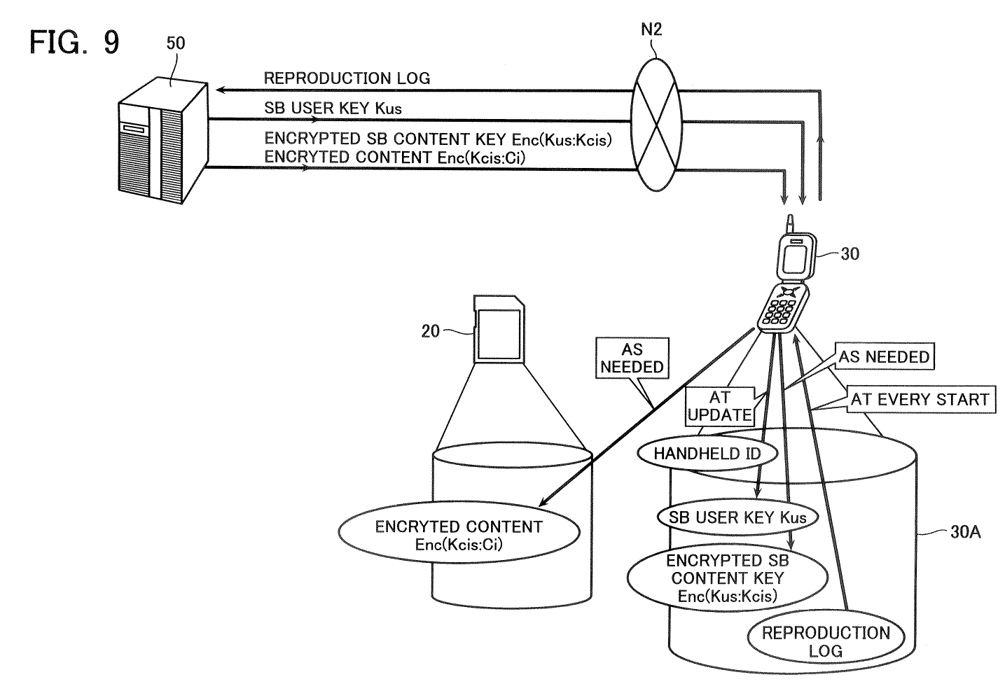

(Third Embodiment) A content data delivery system of a third embodiment of the present invention is described below with reference to FIG. 9. The present embodiment differs from the first embodiment in that the encrypted content data Enc (Kcis:Ci) is downloaded not using the PC 10 or the store terminal 40 but via the handheld terminal 10 and handheld terminal packet network N2. The user connects, at night or whenever the user has time, the SD card 20 to the handheld terminal 30 as needed to download via the handheld terminal packet network N2 the encrypted content data Enc (Kcis:Ci). The corresponding encrypted SB content key data Enc (Kus:Kcis) is also downloaded in parallel to the internal memory 30A of the handheld terminal 30. When the user wishes to reproduce the content data, the user newly makes the member registration or updates the membership to download the SB user key data Kus. Note that the copyright royalty is distributed to the songwriter, composer, artist, and providing company and the like of the viewed and/or heard content data by transmitting the reproduction log information from the handheld terminal 30 to the server 50 as in the first embodiment.

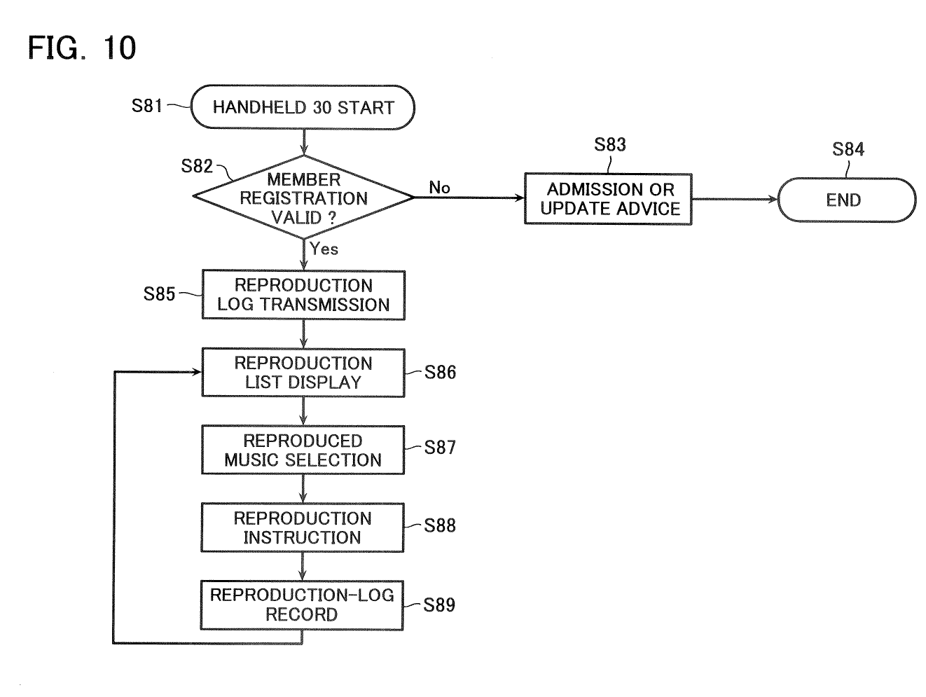

FIG. 10 is a flowchart of the procedure of the reproduction of the content data in the system of the third embodiment. The third embodiment system has the same procedure as the first embodiment system except that the third embodiment system does not compare the content ID list of the content data Ci in the SD card 20 with the list of the content key data Kcis stored in the internal memory 30A in the handheld terminal 30, or download the lacking content key (S6, S7).

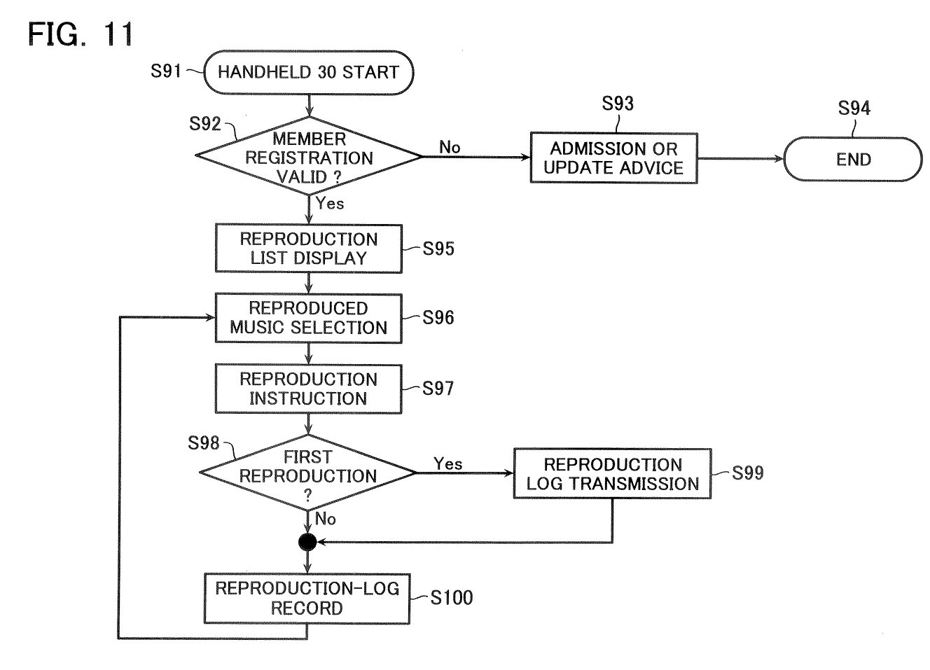

FIG. 11 is a flowchart of another example of the procedure of the reproduction of the content data in the system of the third embodiment. This procedure differs from that in FIG. 10 in that after the reproduction is instructed (S97), it is determined whether the selected content data is on the first reproduction, and if so, then the reproduction log information is updated and transmitted to the server 50 (S98, S99).

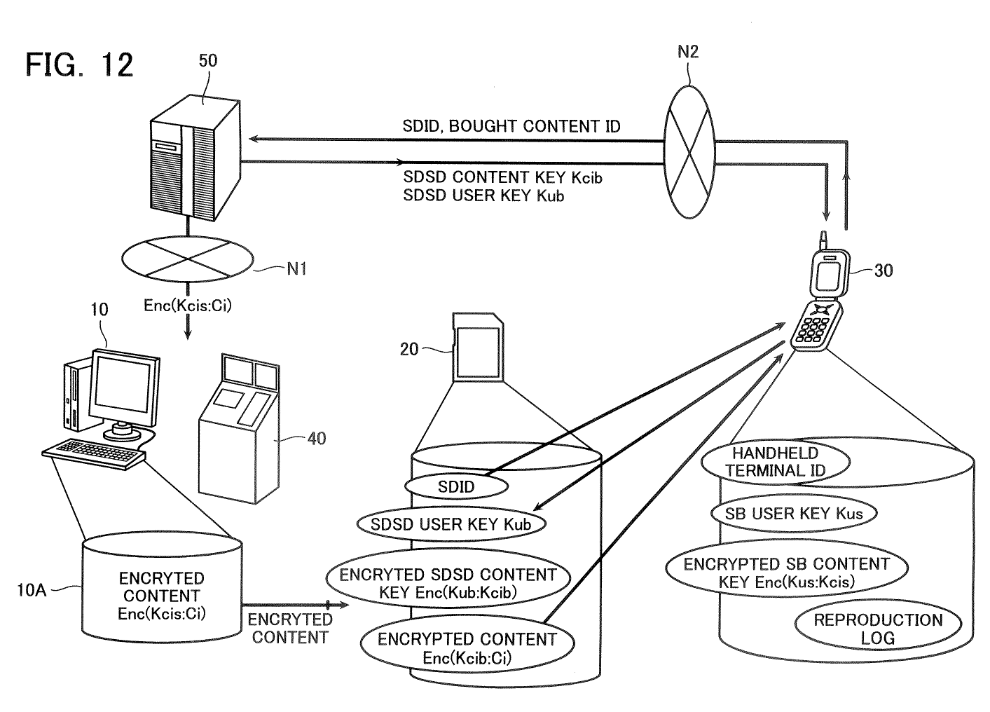

(Fourth Embodiment) A content data delivery system of a fourth embodiment of the present invention is described below with reference to FIG. 12. The system of this embodiment has the same data acquirement procedure in the subscribe format and the same procedure of the content-data reproduction and the like as that in the first embodiment. This embodiment differs from the first embodiment and the like in that the user may buy the content data viewed and/or heard by that user in the subscribe format. Specifically, if the user likes the content data that is being reproduced by the user in the subscribe format, the user may buy the content data by paying a predetermined buy price in stead of continuing paying the membership fee in the subscribe format. After the buy, the user may repeatedly view and/or hear the content data at no charge.

When the user wishes to buy the content data, the user transmits, as shown in FIG. 12, the “buy content ID” of the content data that the user wishes to buy and the media identifier SDID from the handheld terminal 30 to the server 50. The server 50 transmits to the handheld terminal 30, after the payment, SDSD user key data Kub for buy that is different from the SB user key data Kus (subscript b denotes a buy). Although the SDSD content key data Kcib for buy may be the same as the SB content key data Kcis, it is provided with a different symbol for distinction. When the SDSD content key data Kcib is the same as the SB content key data Kcis, the encrypted content key data may not be downloaded again for buy and the server 50 may have less capacity.

The handheld terminal 30 stores the encrypted content data Enc (Kcib:Ci) in the user area of the SD card 20. The SDSD content key data Kcib is encrypted with the SDSD user key data Kub to be an Enc (Kub:Kcib) and then also stored in the user area of the SD card 20. The SDSD user key data Kub itself is stored in the protection area of the SDSD card 20 in such a way that the SDSD user key data Kub may be inaccessible from outside. The content data stored in the SD card 20 may thus be freely reproduced in the subscribe format of the handheld terminal 30 corresponding to the system of the present embodiment as well as in other handheld terminals and common music players.

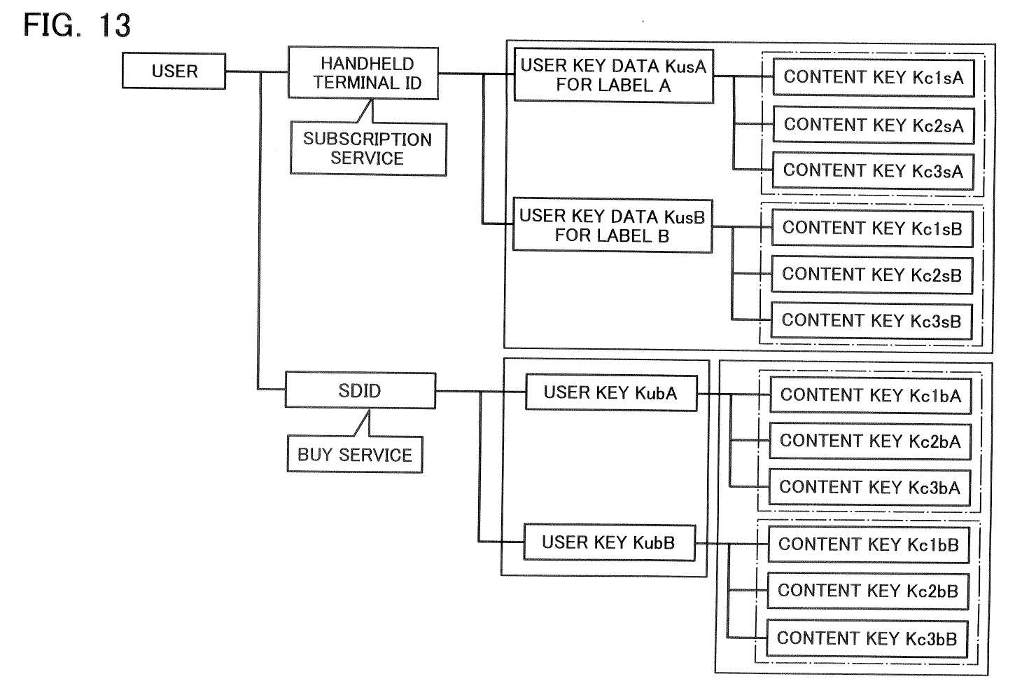

FIG. 13 shows a configuration example of the key data that the user after buying the content data in the system of the fourth embodiment has in the internal memory 30A of the handheld terminal 30 and in the SD card 20. The internal memory 30A of the handheld terminal 30 stores SB content key data Kc1sA, Kc2sA, and Kc3sA that are encrypted with the SB user key data KusA for label A, and SB content key data Kc1sB, Kc2sB, and Kc3sB that are encrypted with the SB user key data KusB for label B. Note that the user key data Kus may be common for each label.

When the content data corresponding to the SB content key data Kc1sA, Kc2sA, Kc3sA, Kc1sB, Kc2sB, and Kc3sB are bought, the SDSD content key data for buy Kc1bA, Kc2bA, Kc3bA, Kc1bB, Kc2bB, and Kc3bB that are the same as the SB content key data Kc1sA, Kc2sA, Kc3sA, Kc1sB, Kc2sB, and Kc3sB are encrypted with the user key KubA (for label A) or KubB (for label B) for SDSD and are then stored in the user area of the SD card 20. As described above, the user key data Kub is securely saved in the protection area of the SD card 20 in the CPRM format, thereby effectively preventing the illegal use of the copyright.

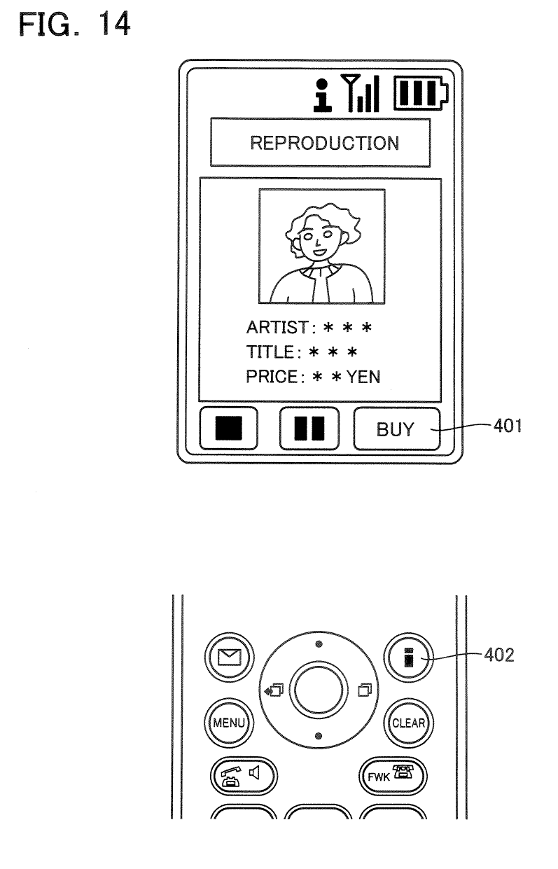

Referring to FIGS. 14 to 18, the buy operation of the content data is described below. As shown in FIG. 14, for example, when the user reproducing the content data in the subscribe format likes the content data and wishes to buy it, the user operates the keyboard 312 to place the cursor or the like on the “buy” icon 401 to select it. Alternatively, the user may press a buy button icon 402 on the keyboard 312 to start the buy procedure.

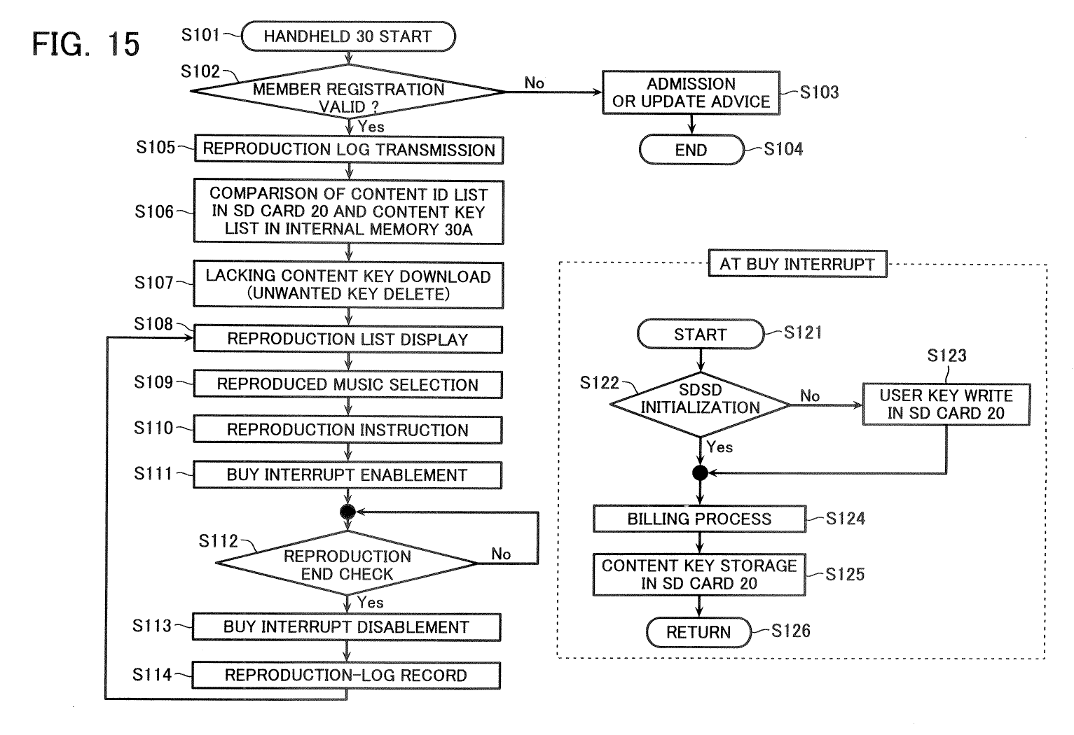

FIG. 15 is a flowchart of the procedure of the reproduction of the content data in the handheld terminal 30 in the system of the fourth embodiment. The flow (S101 to S110, S114) in viewing and/or hearing in the subscribe format is much the same as in the first embodiment (FIG. 3). An interrupt by the buy operation during the content data reproduction is waited for, however, by monitoring, between the reproduction instruction (S110) and the reproduction-log record (S114) after the end of the reproduction, an interrupt by the buy operation, and by enabling, when the buy operation occurs, the interrupt by the buy operation (S111). The end of the content-data reproduction is checked (S112), and after the end, the interrupt by the buy operation is disabled (S113).

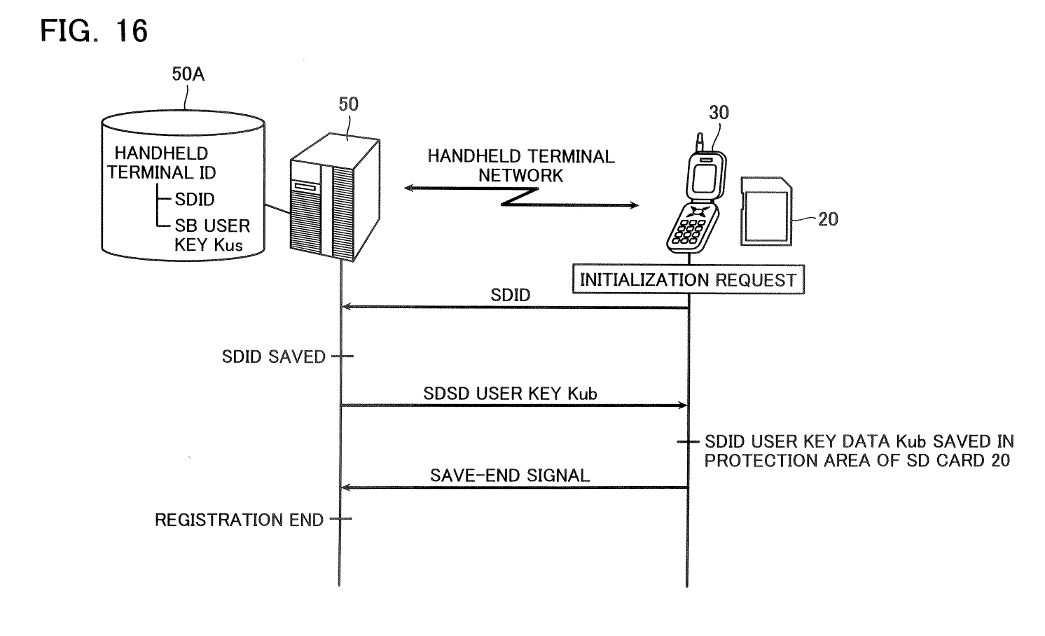

The buy-operation flow at the buy-operation interrupt is shown on the right side of FIG. 15. In this case, the media identifier SDID of the SD card 20 that is to store the content data after buy is transmitted to the server 50 for initialization, thus determining whether the media identifier SDID is already registered (S122). If the media identifier SDID is not yet registered and the SDID user key data Kub is not yet received (NO), the server 50 associates the media identifier SDID with the handheld terminal ID and saves them in the database 50A (see FIG. 16). The server 50 then transmits to the handheld terminal 30 the SDSD user key data Kub corresponding to the SB user key data Kus that has already been delivered to the handheld terminal 30. The SDID user key data Kub is then written in the protection area of the SD card 20, thus completing the initialization (S123). After the save is ended, a save-end signal is transmitted from the handheld terminal 30 to the server 50, thus completing the initialization registration.

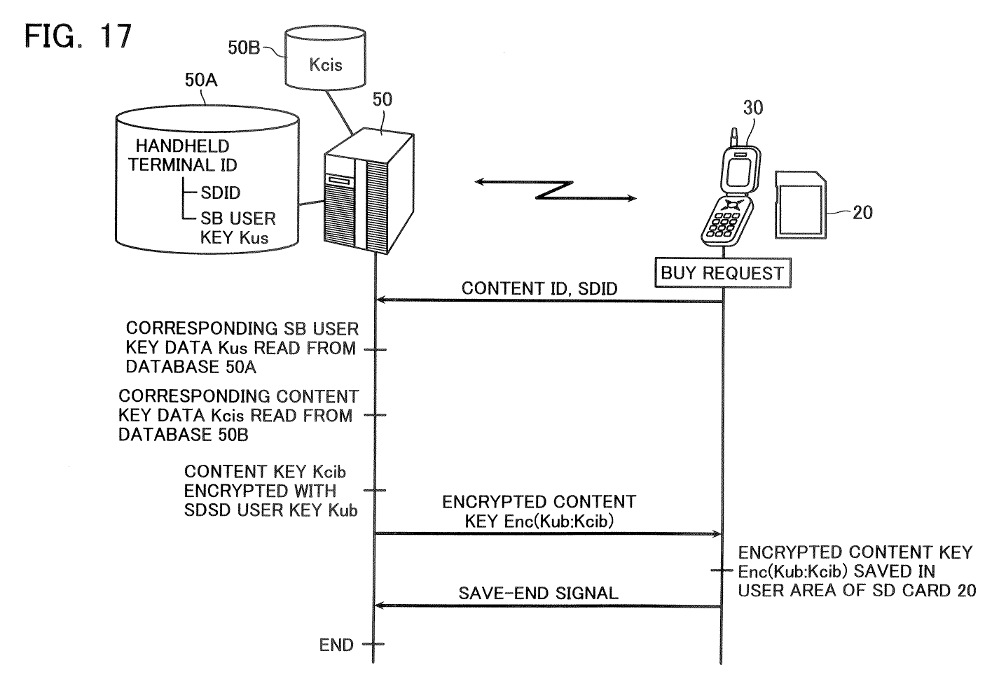

After the initialization is ended, the billing process of the buy is performed (S124), and the SDSD content key data Kcib is encrypted with the SDSD user key data Kub and saved in the user area of the SD card 20 (S125). This procedure is described in more detail with reference to FIG. 17. The correspondence between the media identifier SDID transmitted from the handheld terminal 30 and the handheld terminal ID is revealed by searching the database 50A. The handheld terminal ID is then used to perform the billing process. The server 50 searches the database 50A to read the corresponding SB user key data Kus, and searches the database 50B to read the SB content key data Kcis corresponding to the content ID assigned for buy. The SDSD user key data Kub corresponding to the read SB user key data Kus is used to encrypt the SDSD content key data Kcib corresponding to the SB content key data Kcis, and the encrypted key data is transmitted to the handheld terminal 30. The handheld terminal 30 saves the encrypted content key data Enc (Kub:Kcib) in the user area of the SD card 20. After the save is ended, the save-end signal is transmitted from the handheld terminal 30 to the server 50, thus completing the buy interrupt process.

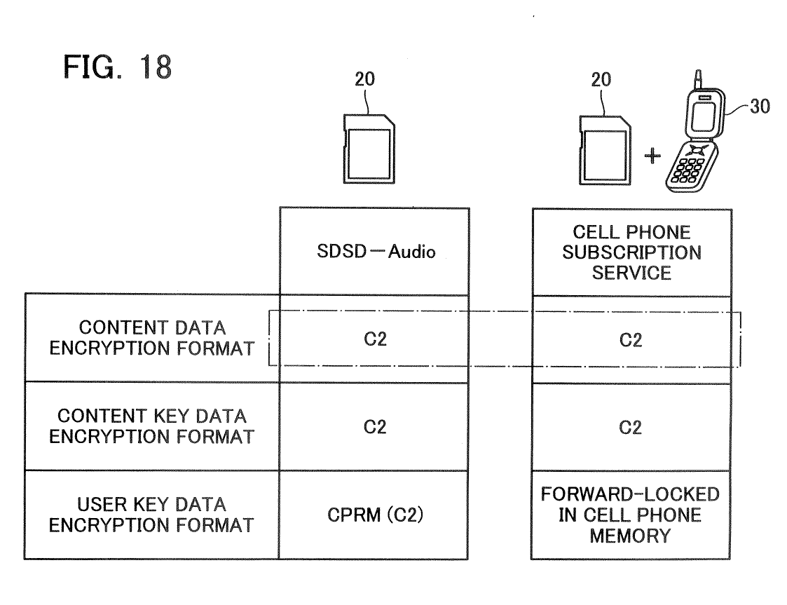

A relationship example of the encryption format of the fourth embodiment with the formats of the subscribe (subscription service) and the buy (SD-Audio) is described with reference to FIG. 18. In either format, the encryption algorithm of the content data and the content key data may use the so-called C2 (Cryptomeria Cipher). This holds true for the encryption algorithm of the user key data in the buy format. The user key data in the subscribe format is encrypted in a format that is forward-locked, by the application stored in the handheld terminal 30, in the handheld terminal 30.

Thus, although the invention has been described with respect to particular embodiments thereof, it is not limited to those embodiments. Various modifications and additions and the like may be made without departing from the spirit of the present invention. For example, the delivery method of the first to third embodiments as described above may be selected in one system as appropriate depending on the user's wish.

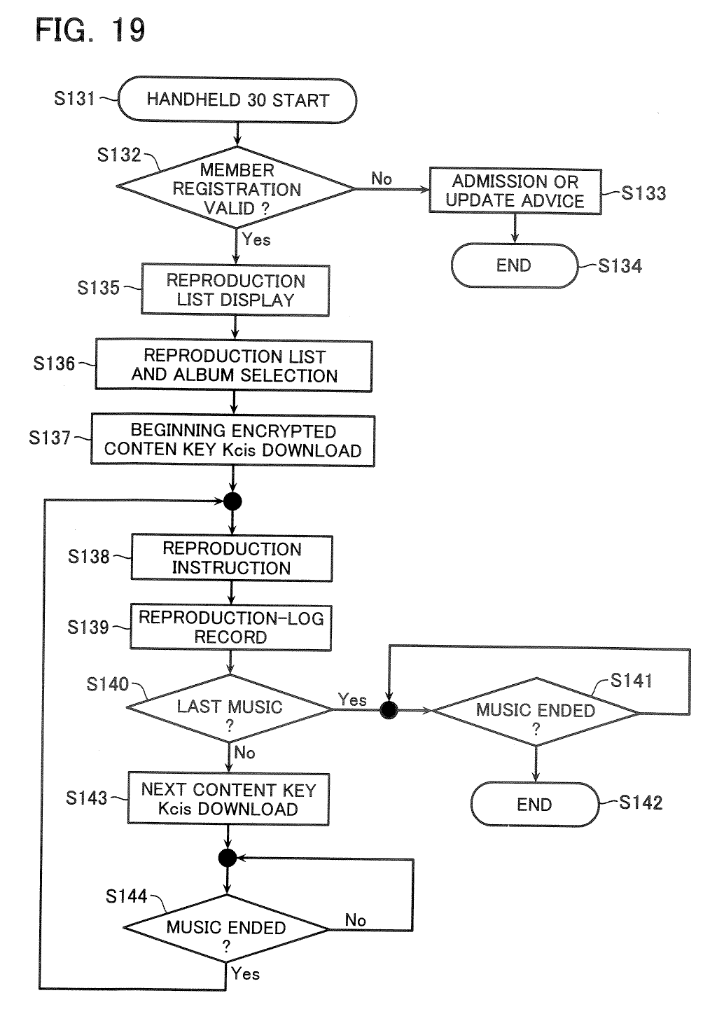

Although, for example, the first embodiment compares the content ID list of the content data Ci in the SD card 20 with the list of the content key data Kcis stored in the internal memory 30A in the handheld terminal 30 and downloads the lacking content key data collectively (S6 in FIG. 3, for example), every time one set of the content data is reproduced, the content key data of the next content data to be reproduced may be downloaded. FIG. 19 shows an example where the reproduction list lists album names each including a plurality of songs and when an album name is selected a plurality of songs in that album are continuously reproduced. When an album is selected (S136), the encrypted content key data Kcis of the beginning song of that album is downloaded to the handheld terminal 30, which starts to reproduce the beginning song. During the reproduction, it is determined whether the song being reproduced is the last song in the album (S140). If not, then the content key data Kcis of the next song starts to be downloaded (S143). After the reproduction of the song is ended, the content key data Kcis of the next song newly downloaded is used to start to reprocuce the next song. If the song being reproduced is the last song in the album (YES at S140), then the reproduction operation is ended at the song's end (S142).

The present embodiment may issue a group including a plurality of members with one SB user key data Kus, which is shared by the plurality of members. Such a format may be used effectively when, for example, the education at a music college or the like delivers assignment music to the students or a foreign language college or the like delivers English teaching materials or the like.

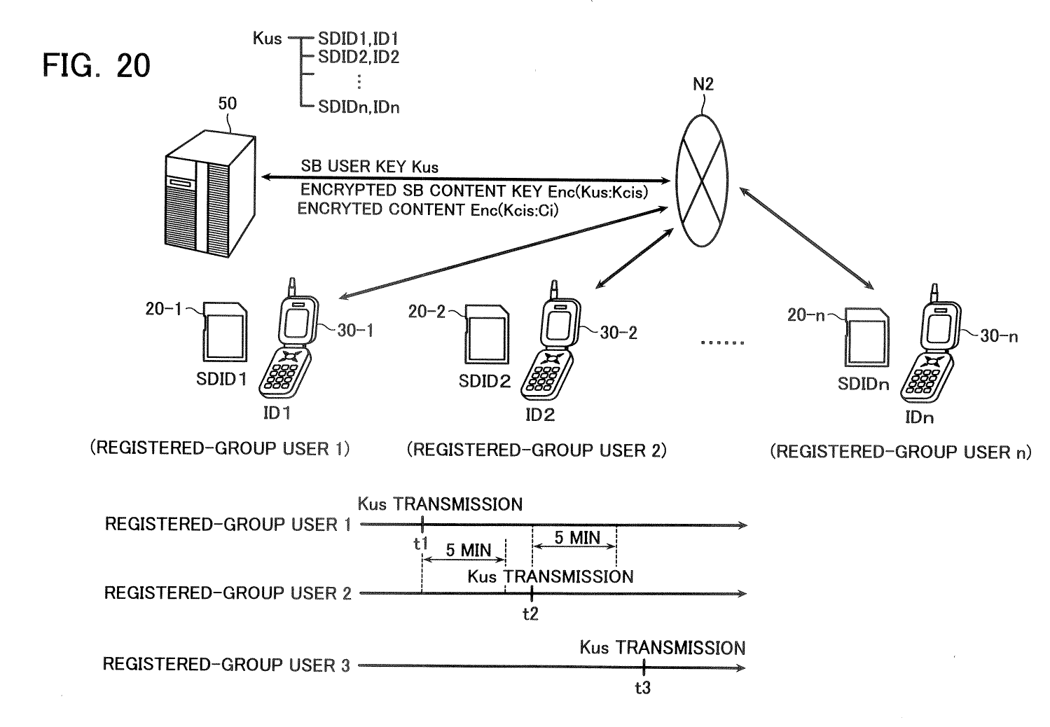

As shown in FIG. 20, for example, a plurality of members belonging to a group are registered as registered-group users 1, 2, . . . , n in the database coupled to the server 50. Each registered-group user i registers his/her handheld terminal 30-i's handheld terminal ID (IDi) and SD card 20-i's media identifier (SDIDi) in the database. The registered-group user i transmits his/her handheld terminal ID and the media identifier to the server 50, when the user accesses the server 50 with the handheld terminal 30, to receive authentication from the server 50. Each handheld terminal 30-i receives the authentication and the SB user key data Kus transmitted to the handheld terminal 30-i. The server 50 concurrently communicates with the contracted number of registered-group users i, for example, only one. As shown in FIG. 20, for example, when the registered-group user 1 accesses the server 50 to receive the user key data Kus, the server 50 may not accept accesses from the other registered-group users for a time necessary, for example, to reprocuce the corresponding content data (for example, five minutes).

What is claimed is:

1. A method of delivering content data that makes content data able to be reproduced at a user terminal by delivering content key data necessary to decrypt the content data, comprising:
connecting portable storage media storing in advance said content data encrypted with said content key data to said user terminal having a unique terminal ID;
transmitting, from a server via a first network to said user terminal, user key data that is provided with a predetermined expiration date and is necessary to encrypt said content key data, and storing said user key data in an internal memory of said user terminal in such a way that said user key data is unable to be read out of said internal memory, said internal memory being under control of application software stored in said user terminal; and
encrypting said content key data necessary to decrypt said content data stored in said portable storage media with said user key data, and storing the encrypted content key data in said user terminal or said portable storage media.

2. The method according to claim 1, wherein said content data encrypted with said content key data is stored in said portable storage media by connecting said portable storage media to a different communication terminal connected to a second network that is different from said first network, and transmitting to the different communication terminal from said server said encrypted content data.

3. The method according to claim 2, wherein said content key data is encrypted with said user key data and is then transmitted from said server via said first network to said user terminal and is stored in a memory in said user terminal.

4. The method according to claim 3, further comparing content data recorded in said portable storage media and content key data stored in a memory in said user terminal, determining lacking content key data at said user terminal, and transmitting the lacking content key data from said server to said user terminal.

5. The method according to claim 2, wherein said content key data is encrypted with said user key data and is then transmitted from said server via said second network to said different communication terminal and is stored in said portable storage media.

6. The method according to claim 5, wherein the transmission of said content key data to said different communication terminal comprises associating a media identifier of said portable storage media with the terminal ID of said user terminal and storing them in said server.

7. The method according to claim 1, wherein said content data encrypted with said content key data is stored in said portable storage media, after said portable storage media is connected to said user terminal, via said first network.

8. The method according to claim 1, wherein said user terminal transmits reproduction log information that specifies reproduced content data to said server, and said server performs, according to the reproduction log information, a billing process.

9. The method according to claim 1, wherein said user key data is updated by said server every predetermined period.

10. The method according to claim 1, wherein the application software in said user terminal counts up a use counter every time said user terminal accesses said server, and allows, when said use counter reaches a count value equal to or greater than a predetermined value, said user terminal to perform an authentication operation, and resets, when said authentication operation is complete, said use counter's count value.

11. The method according to claim 1, further comprising allowing, when buy of said content data is assigned at said user terminal, said server to write in said portable storage media said user key data stored in a memory in said user terminal and/or user key data corresponding to said user key data and/or said content key data, and to write at least said user key data in an area in said portable storage media that is inaccessible from outside.

12. The method according to claim 1, wherein said user key data is issued to a group having a plurality of members and is shared by the plurality of members, and a predetermined number of said plurality of members are permitted to access said server from said user terminal.

13. A communication terminal that is adapted to be able to connect to portable recording media storing content data encrypted with content key data and is adapted to be able to receive from an external server user key data that is provided with a expiration date and is necessary to encrypt at least said content key data, comprising:
an internal memory having an protection area that is able to store various data in such a way that the data is unable to be read out of said protection area; and
application software that is stored in said internal memory and performs a communication control to receive at least said user key data from said server via a first network,
wherein
said application software has functions of storing said user key data in said protection area in said internal memory and receiving authentication from said server and update of said expiration date.

14. The communication terminal according to claim 13, wherein
said content data encrypted with said content key data is stored, via a second network that is different from said first network and using a different communication terminal, in said portable storage media, and
said application software has functions of comparing said content data stored in said portable storage media with said content key data corresponding to said content data stored in said internal memory, and receiving lacking content key data transmitted from said server.

15. The communication terminal according to claim 13, wherein
said content key data encrypted with said user key data and said content data encrypted with said content key data are stored, via a second network that is different from said first network and using a different communication terminal, in said portable storage media, and
said application software has functions of indicating a media identifier of said portable storage media to said server, and storing in said server relevant information that associates said portable storage media with said communication terminal.

16. The communication terminal according to claim 13, wherein said application software has a function of receiving said content data encrypted with said content key data via said first network from said server.

17. The communication terminal according to claim 13, wherein said application software has a function of, when buy of said content data is assigned and after the buy information is transmitted to said server and a payment is made, writing in said portable storage media said user key data stored in said internal memory and/or user key data corresponding to said content key data and/or content key data, and writing at least said user key data in an area in said portable storage media that is inaccessible from outside.
